(19) United States
(12) Patent Application Publication
(10) Pub. No.: US 2018/0370328 A1
(43) Pub. Date: Dec. 27, 2018

(54) METHOD FOR AIR CONDITIONING AN INTERIOR OF A VEHICLE

(71) Applicant: FORD GLOBAL TECHNOLOGIES, LLC, Dearborn, MI (US)

(72) Inventors: Ingo Krolewski, Neuss (DE); Ger Anthony Cronin, Pulheim (DE)

(21) Appl. No.: 16/016,181

(22) Filed: Jun. 22, 2018

(30) Foreign Application Priority Data
Jun. 27, 2017 (DE) 102017210826.6

(51) Int. Cl. B60H 1/00; B60H 1/32

(52) U.S. Cl. CPC B60H 1/00778; B60H 1/00878; B60H 2001/3255; B60H 1/3207; B60H 2001/3245; B60H 1/00821

(57) ABSTRACT

A method for air-conditioning an interior of a vehicle to prevent fogging of the windows when at least one identifiable user enters the vehicle. The vehicle has a vehicle communication device which communicates with at least one user communication unit, a climate detection device for detecting the climate in the interior of the vehicle or for detecting the climate in the interior and in the area surrounding the vehicle, as well as a climate modification device for changing the climate in the interior of the vehicle. The method comprises steps of: checking by means of whether an identifiable user is approaching the vehicle, testing whether a fogging of at least one of the windows of the vehicle is to be expected when the user enters the vehicle, and air-conditioning the interior of the vehicle in such a way that fogging of the windows of the vehicle is prevented.

### TECHNICAL FIELD

This document relates to a method for air conditioning an interior of a vehicle in such a way that fogging of the windows of the vehicle is prevented. This document also relates to a vehicle which is designed to carry out such a method, and a computer program product for carrying out such a method.

### BACKGROUND

Fogged window panes constitute a danger in vehicles, in particular in the case of motor vehicles, since they restrict the vision from the interior of the vehicle into the surrounding area and the driver cannot therefore observe the traffic. In such a situation the driver is forced to stop, and to remove the condensed water on the windows with a cloth. This is both time-consuming and laborious, and moreover, it is not uncommon for the windows to become fogged again after a short period of time, so that the window panes must be cleared of the condensed water again.

Some approaches to counteracting the fogging on the windows rely on a corresponding activation of the air-conditioning system of the vehicle. Methods such as these, which are designed to prevent fogging of the windows, are disclosed in DE 10 2011 084 278 A1 and DE 10 2016 210 038 A1. These methods are aimed mainly at preventing fogging of the windows while driving. In many cases, however, the window panes become fogged when at least one user enters the car and intends to drive off. In this case, such methods only deliver their effect once the user has selected the appropriate program of the air-conditioning system and this has been running for a certain length of time. Therefore, the user must wait as long as it takes for the window panes to be clear again before he/she can begin the journey.

It is an objective hereof to specify a method for air conditioning an interior of a vehicle, which either prevents the windows from fogging when at least one identifiable user gets into the vehicle, or else reduces the time required to remove the condensation on the windows by a significant amount compared to known methods from the prior art. It is a further object to create a vehicle which is configured for carrying out this method. Still further, it is an object hereof to provide a computer program product for carrying out this method.

These objects are achieved with the features specified in the claims that follow.

### SUMMARY

In accordance with the purposes and benefits described herein, a method is provided for air-conditioning an interior of a vehicle in such a way that fogging of the windows of the vehicle is prevented. When at least one identifiable user enters the vehicle, the vehicle has a vehicle communication device which communicates with at least one user communication unit, a climate detection device for detecting the climate in the interior of the vehicle or for detecting the climate in the interior and in the area surrounding the vehicle, as well as a climate modification device for modifying the climate in the interior of the vehicle. The method comprises the following steps:
testing by means of the vehicle communication device whether an identifiable user is approaching the vehicle,
in the event that an identifiable user is approaching the vehicle, testing by means of the climate detection device whether fogging of at least one of the windows of the vehicle is to be expected when the user enters the vehicle, and
in the event that fogging of at least one of the windows of the vehicle is to be expected, air-conditioning the interior of the vehicle by means of the climate modification device in such a way that fogging of the windows of the vehicle is prevented.

An essential idea of the present method is not to wait until the user has or users have already boarded the vehicle to air-condition the interior so that the windows no longer fog, but to air-condition the interior already before the user has or the users have boarded. The method proposed tests whether an identifiable user is approaching the vehicle. An identifiable user is to be understood as a user who is authorized to board the vehicle. The user communication unit signals to the vehicle communication device whether a user is authorized or not.

If an identifiable user does approach the vehicle, then the currently prevailing climate in the interior is detected by means of the climate detection device, which then checks whether fogging of at least one of the vehicle windows of the vehicle is likely. This process may take into account the fact that the user or users emit a certain amount of moisture through their breath, which can lead to a fogging of the windows. It is possible to use a dedicated user communication unit per user. The vehicle communication system can be used to determine how many identifiable users are approaching the vehicle. With the increasing number of users boarding the vehicle, the quantity of moisture that the users impart into the interior through their breath also increases.

In the event that fogging of the windows is to be expected, then before the occupants board the vehicle the climate modification device initiates appropriate steps to air-condition the interior so that, if the user or users board(s) the vehicle, the risk of the window panes fogging is at least significantly reduced. With the proposed method the interior can be already appropriately air-conditioned if the danger of fogging exists. In general, the user cannot detect whether or not there is a risk of fogging, and can only take counter-measures when the windows actually start to fog. With the present method, the extra time up to this point is gained and fogging is thus prevented, or at least the time required to remove the condensation from the window panes is significantly reduced.

In accordance with another embodiment, the vehicle comprises an air-conditioning system. The step of air-conditioning the interior of the vehicle comprises actuation of the air-conditioning system by means of the climate modification device, in such a way that fogging of the windows of the vehicle is prevented. This step is also executed before the user or users board(s) the vehicle. As a result, the user does not need to first switch on the air-conditioning system and select the appropriate program, so that here, too, the amount of time that the user must wait to begin the journey is significantly reduced. To this end it may be necessary to start the engine of the vehicle, which is performed by the climate modification device.

In some cases, the windows do not fog immediately when the user or users enter(s) the vehicle, but shortly thereafter, for example, in a period of between one and five minutes. In this time the user may have already started driving. The user can then only operate the air-conditioning system appropriately when he/she notices that the panes of glass in the windows start to fog. The method according to the invention on the other hand already cuts in before the windows have even started to fog, but the risk of this nevertheless still exists. Consequently, the interior can be pre-emptively air-conditioned so that fogging is prevented. This not only renders the tedious task of clearing the condensation from the windows superfluous, but also contributes to the operational safety of the vehicle concerned, since the window panes are prevented from fogging while driving and thus vision is no longer degraded.

In an extended embodiment, the air-conditioning system can be operated in recirculation mode. As mentioned earlier, the climate detection device can not only detect the current climate in the interior space, but instead can be configured so that it can also detect the climate in the immediate vicinity of the vehicle. If the climate detection device detects that the moisture level in the interior of the vehicle is lower than in the surrounding area, which would be the case, for example, if it is raining in the area surrounding the vehicle, then using the recirculation mode, moist air from the environment can be prevented from reaching the interior of the vehicle. This also prevents the windows from fogging up.

In an extended embodiment, the vehicle can have automatically lowerable windows and/or an automatically actuatable sunroof, and the step of air-conditioning the interior of the vehicle can comprise actuation of the windows and/or the sunroof by means of the climate modification device, in such a way that a fogging of the windows of the vehicle is prevented. Not all vehicles are equipped with an air-conditioning system. Nevertheless, the proposed method can also be implemented if the vehicle is not equipped with an air-conditioning system. In this case it can be tested whether the fogging of the windows can be prevented by lowering at least one of the window panes and/or by opening the sunroof. This is particularly useful when the air in the area surrounding the vehicle is significantly drier than in the interior. Even if the vehicle in question has an air-conditioning system, the lowering of the windows and/or opening of the sunroof can be useful, because the resulting energy consumption is lower compared to a corresponding control of the air-conditioning system. In this respect, this contributes to the resource-conserving operation of the vehicle.

In a further embodiment, the climate detection device can comprise a temperature sensor, a moisture sensor and/or a rain sensor, the measurement data of which are taken into account when detecting the climate in the interior of the vehicle or when detecting the climate in the interior and in the area surrounding the vehicle. Modern vehicles already have a large number of sensors, so that temperature sensors, moisture sensors and/or rain sensors are typically present. The measurement data generated by them can be taken into account by the climate detection device. The temperature and humidity are a major factor in the fogging of the windows, so that by taking account of the measurement data generated by the temperature sensors and humidity sensors a fairly accurate assessment can be made as to whether the windows will fog or not when a user boards the vehicle. The measurement data of a rain sensor may also be taken into account, as rain is associated with an increased moisture content of the air in the environment of the vehicle concerned. As previously discussed, one embodiment of the proposed method provides for lowering the windows and/or opening the sunroof in order to prevent fogging of the window panes. These measures are of course only practical if it is not raining. Taking into account the measurement data of the rain sensor prevents lowering of the windows and/or opening of the sunroof in the rain. If the vehicle is a convertible, the roof can be opened provided it is not raining.

In accordance with another embodiment, the user communication unit comprises a car key. Modern vehicles are equipped with car keys which open the vehicle lock when the car key is brought into a specific area around the vehicle. In this respect, information can be obtained as to whether the user is in the area surrounding the vehicle or not. The car key transmits identification signals to the vehicle communication device, so that the vehicle lock can only be opened with a small number of car keys. Therefore, the car key is also used to identify the user at the same time. If the identified user is located in the vicinity of the vehicle, it can be assumed that the user would like to board the vehicle and begin to drive. This information can be used to initiate the steps given above for preventing the fogging of the windows. This allows additional time to be gained for the climate control of the vehicle interior.

An extended embodiment is characterized in that the user communication unit comprises a smartphone, a tablet and/or a wearable device, the measurement data of which are taken into account by the climate modification device when testing whether a fogging of at least one of the windows of the vehicle is to be expected when the user boards the vehicle.

Wearable devices are defined as portable data processing devices, which during their operation are worn on the user's body. With smartphones, tablets and/or wearable devices it is also possible to determine whether a user is located in the vicinity of the vehicle or not. Therefore, it is possible to use the information regarding the location of the user generated by the smartphones, tablets or wearable devices in order to initiate the above steps for preventing the fogging of the windows. In contrast to car keys, which can only determine the presence of the user within a relatively narrowly defined environment of the vehicle, smartphones, tablets and wearables usually have GPS transmitters, so that the measures described above for preventing the fogging of the windows of the vehicle can be initiated even when the user is still a long way away from the vehicle. This also allows further time to be gained to initiate the necessary measures for the climate control of the interior.

In particular the wearables, but also the smartphones and tablets, can also provide additional information, which can be taken into account when air-conditioning the interior of the vehicle. By means of the GPS transmitter it is possible to determine the speed at which the user is moving. In particular, it can be determined whether the user in question is running and how long he/she has been running for. This can be used to determine whether the user is sweating and will thus introduce an increased level of moisture into the interior. Wearable devices are also capable of measuring how heavily the user is sweating, by measuring their skin resistance. This information can be taken into account in the climate control of the interior, so that the risk of fogging of the windows can be reduced significantly.

US 2015/0127215 A1 discloses the concept of storing user-specific settings, such as the seat position, on the wearable devices. If another user with their own wearable approaches the vehicle, this user's individual settings are implemented, before he/she has entered the vehicle. US 2015/0127215 A1 does not disclose, however, the idea of using the data generated by the wearable device regarding, for example, physical activity in order to air-condition the vehicle interior before the user enters so as to prevent fogging.

The smartphones, tablets and wearables can use appropriate transmission standards such as Bluetooth or Wi-Fi to communicate wirelessly with the vehicle communication device and transmit their measurement data. In addition, the smartphones, tablets and wearables are coupled to the vehicle communication device with an initial pairing so that communication is enabled. The communication facility can also be used to identify the user of the relevant smartphone, tablet and wearable device.

In accordance with an additional aspect, a computer program product is provided for carrying out a method according to any one of the previous embodiments.

In addition, in accordance with yet another aspect, a vehicle, in particular a motor vehicle, is provided which is configured for carrying out a method according to any one of the previous embodiments.

The technical effects and advantages that can be obtained with the computer program product according to the proposal and the present vehicle correspond to those which have been discussed for the present method. In summary, it should be noted that according to the proposal it is already possible to take measures which prevent the fogging of the windows before the user boards the vehicle. It is therefore not necessary to clear the windows of the condensation with a cloth, nor to wait until the air-conditioning system has air-conditioned the interior so that the windows are no longer fogged. Thus, on the one hand, the time needed to clear the window panes of the condensate is reduced, and on the other hand, a contribution is made to the operational safety of the vehicle concerned, since it is possible to prevent the windows from fogging shortly after starting and therefore the visibility through the windows from being degraded.

### BRIEF DESCRIPTION OF THE DRAWING FIGURES

In the following, the new and improved method, computer program and vehicle are described in greater detail with reference to the enclosed drawings. Shown are:

FIG. 1a a schematic plan view of a vehicle, which can be operated with the method,

FIG. 1b the vehicle shown in FIG. 1a) in a schematic sectional view, so that components fitted in the vehicle are visible,

FIG. 2 a schematic representation of the method, and

FIG. 3 a flow diagram of the method.

### DETAILED DESCRIPTION

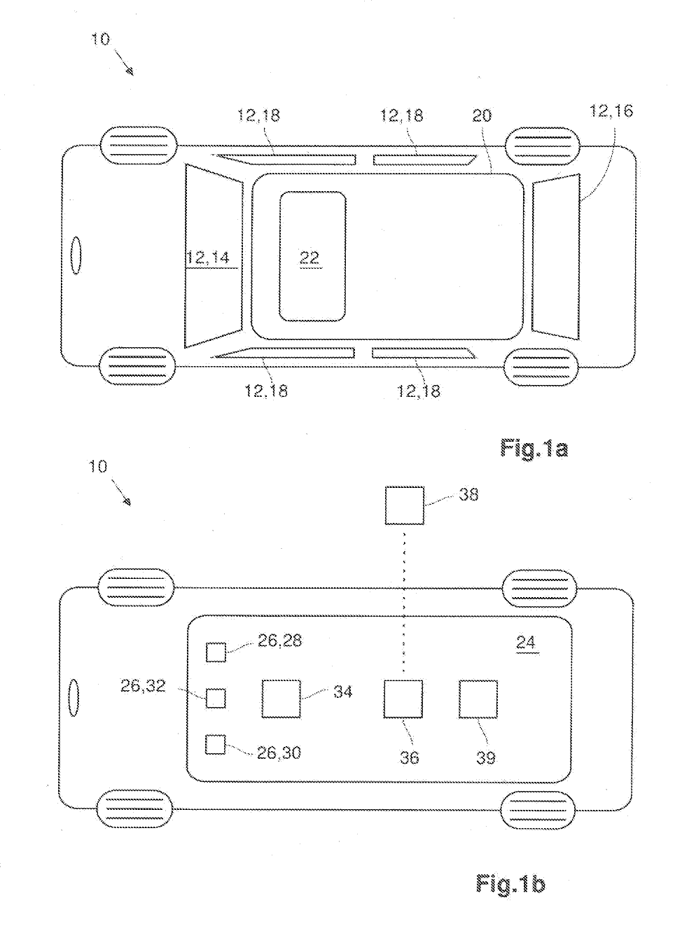

FIG. 1a shows a schematic view of a vehicle 10, which is configured in such a way that the new and improved method can be carried out. The vehicle 10 has a total of six windows 12, namely a windshield 14, a rear window 16 and four side windows 18. The side windows 18 are automatically retractable, wherein the necessary window controls and the drive means are not shown. The vehicle 10 also comprises a vehicle roof 20, in which an automatically actuatable sunroof 22 is arranged, wherein the drive means are not shown here either.

As can be seen from FIG. 1b, the vehicle 10 has an interior 24, which is bounded by the windows 12 and the roof of the vehicle 20, among other things. The vehicle 10 is equipped with a climate detection device 26 with which the climate in the interior 24 of the vehicle 10 can be detected. The climate detection device 26 comprises a temperature sensor 28 and a humidity sensor 30 for the purpose. The climate in the interior 24 can therefore be characterized and quantified in terms of its temperature and moisture level. Another way to characterize and quantify the climate would be to use a barometer to measure the air pressure in the interior 24 (not shown).

The temperature sensor 28 and the moisture sensor 30 are configured so that they can characterize and quantify the climate not only in the interior 24 but also in the area surrounding the vehicle 10. In addition, the climate detection device 26 comprises a rain sensor 32, which can be used to determine whether and how hard it is raining in the area surrounding the vehicle 10.

The vehicle 10 also comprises a climate modification device 34, which can be part of the control unit of the vehicle 10. In addition, the vehicle 10 comprises an air-conditioning system 39. The climate modification device 34 detects the measurement data generated by the climate detection device 26 and takes appropriate measures in order to selectively modify the climate in the interior 24. These measures will be explained in more detail later.

The vehicle 10 is also equipped with a vehicle communication device 36, with which the vehicle 10 can communicate and exchange data with a user communication unit 38.

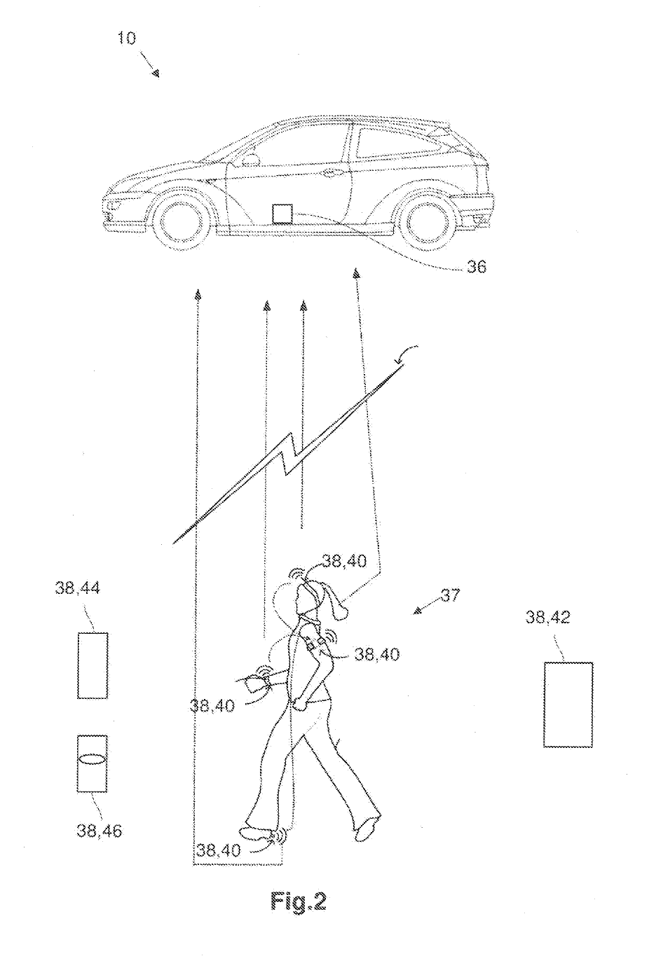

FIG. 2 shows an embodiment of the way the communication between the vehicle communication device 36 and the user communication unit 38 can be implemented. The vehicle 10 shown in FIG. 2 has the components described in FIGS. 1a and 1b, including, among other things, the vehicle communication device 36. The user 37 shown in FIG. 2 carries the user communication unit 38, which is implemented as a number of wearables 40. In addition, it shows schematically that the user communication unit 38 can also be implemented as a tablet 42, a smartphone 44 or a car key 46.

Irrespective of how the user communication unit 38 is implemented, this makes contact wirelessly with the vehicle communication device 36, for example via Bluetooth or WIi-Fi. Before first use a pairing is made between the user communication unit 38 and the vehicle communication device 36, in order to enable communication. This also classifies the user 37 of the user communication unit 38 as an identifiable user 37, who is entitled to enter the vehicle 10.

In the example of the wearables 40 worn by the user 37, these measure a plurality of user-related data, for example, the position, the speed, the heart rate, skin temperature, blood pressure, and skin resistance. This makes it possible to determine whether or not the user 37 is currently involved in sporting activity and how heavily he/she is sweating. This information is important to the extent that in the case of heavy sweating on the part of the user 37, a quantity of moisture enters the interior 24 of the vehicle 10 via the skin in addition to the breath.

The measurement data generated by the wearables 40 can be transmitted to the vehicle communication system 36 either continuously or only when the user 37 is located within a selectable distance of the vehicle 10. Based on the position measurement it is possible to determine whether the user 37 intends to enter the vehicle 10 within a certain period of time. If this occurs, the vehicle communication device 36 transmits the measurement data determined by the wearables 40 to the climate modification device 34. Wearables 40 from more than one user 37 that communicate with the vehicle communication device 36 can also be used. In that case the climate modification device 34 additionally receives an indication of whether or not more than one user 37 is entering the vehicle 10, and whether the users 37 are sweating. The climate modification device 34 can determine whether the currently prevailing climate in the interior 24 is likely to result in fogging of the windows 12 if the user 37 or the users 37 board the vehicle 10.

If it can be expected that the windows 12 will fog when the user or users 37 board(s) the vehicle 10, the climate modification device 34 can take the following measures: it can switch on the air-conditioning system 39 of the vehicle 10 and operate it such that fogging of the windows 12 is prevented when the users 37 board the vehicle 10. This can be effected, for example, by increasing the temperature of the air, thereby increasing its capacity to absorb water. Furthermore, the air-conditioning system 39 can be operated in recirculation mode, which makes sense if the moisture level in the area surrounding the vehicle 10 is greater than in the interior 24. Should it be necessary to start the engine of the vehicle 10 in order to be able to operate the air-conditioning system 39 appropriately, this is performed by the climate modification device 34.

In addition, the climate modification device 34 can lower the side windows 18 and/or open the sunroof 22. If the vehicle 10 concerned is a convertible, then the roof can be opened. The rain sensor 32 checks whether or not it is raining in the area surrounding the vehicle 10. In particular, the sunroof and the top of the convertible are only opened if it is not raining.

As already mentioned, the user communication unit 38 can also be implemented as a tablet 42, a smartphone 44 or a car key 46. Smartphones in particular have acceleration sensors, which can be used to determine whether the user 37 is walking or running. The GPS transmitters can be used to determine how fast the user 37 is moving. Even if, in contrast to wearables 40, there is no means of measuring the pulse, blood pressure and skin resistance and thus of determining whether and, if so, how much the user 37 is sweating. However, on the basis of previous experience it can be estimated that a user 37 who is moving at a running speed over a fairly long period of time will be sweating. In addition, the climate modification device 34 can be designed to be self-learning, so that the increase in moisture when boarding the vehicle 10 is correlated with the physical activity of the user and, therefore, an estimate can be made as to the moisture input which is likely to occur in a comparable situation.

The behavior is somewhat different in the case when the user communication unit 38 is designed as a car key 46. The car key 46 is usually not equipped with a GPS sensor and not in a position to determine the physical activity of the user. Instead, it is only possible to determine whether or not the user 37 is within a certain radius around the vehicle 10. If the climate detection device 26 were to detect a climate in the interior 24, in which given a normal level of physical activity of the user fogging of the windows 12 would be expected, then the climate modification device 34 can initiate the described measures.

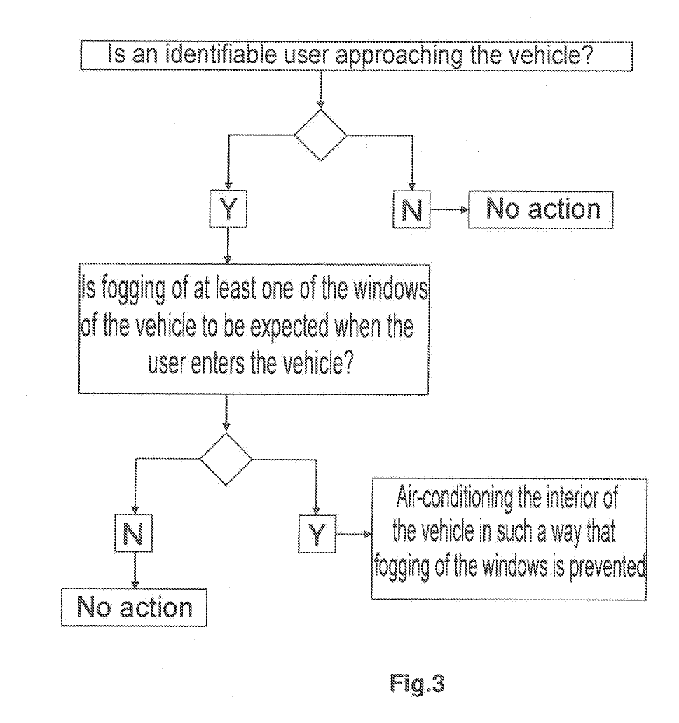

As shown in FIG. 3, regardless of the specific embodiment of the user communication unit 38, using the current method it is determined whether or not an identifiable user 37 is approaching the vehicle 10. In addition, it is determined whether fogging of at least one of the windows 12 is to be expected when the user 37 enters the vehicle 10. In doing so, all available relevant information is taken into account to be able to make the most accurate possible assessment of this. If a fogging of the windows 12 is to be expected, the interior 24 is air-conditioned such that fogging is prevented when the user 37 enters the vehicle 10.

Even if, for example, when the user communication unit 38 is a car key 46, only relatively little relevant information is available, the method nevertheless offers a significant advantage. In most cases, the user 37 is not aware of the fact that the windows 12 will soon start to fog, because the windows 12 often do not fog immediately after the user enters the vehicle 10, but only some time later. Only then will the user 37 adjust the air-conditioning system 39 so that the windows 12 are cleared of condensation. Even if the air-conditioning system 39 is appropriately operated or if the other measures described are taken for only a short time before the user enters, it is possible to prevent fogging of the windows 12.

It is expedient to design the vehicle 10 in such a way that a message is issued to the user 37, according to which there is a risk of the windows 12 fogging and that the described counter measures have been taken. This message can be provided via a display in the vehicle 10 or via the user communication unit 38. Issuing the message via the user communication unit 38, for example via the smartphone 44, has the advantage that the user is already informed about the measures that have been initiated before reaching the vehicle 10 and so does not wonder why, for example, the engine is running and the side windows 18 have been lowered.

What is claimed:

1. A method for air-conditioning an interior of a vehicle, in such a way that fogging of windows is prevented when an identifiable user enters the vehicle, comprising:
testing, by a vehicle communication device, whether the identifiable user is approaching the vehicle,
in the event the identifiable user is approaching the vehicle, testing, by climate detection device, whether fogging of at least one of the windows of the vehicle is to be expected when the identifiable user enters the vehicle, and
in the event that fogging of at least one of the windows of the vehicle is to be expected, air-conditioning the interior of the vehicle, by climate modification device, in such a way that fogging of the windows of the vehicle is prevented.

2. The method as claimed in claim 1, wherein the step of air-conditioning the interior of the vehicle comprises actuation of an air-conditioning system by the climate modification device, in such a way that fogging of the windows of the vehicle is prevented.

3. The method as claimed in claim 2, including operating the air-conditioning system in recirculation mode.

4. The method as claimed claim 3, wherein the step of air-conditioning the interior of the vehicle comprises opening of windows by the climate modification device in such a way that fogging of the windows of the vehicle is prevented.

5. The method as claimed claim 4, wherein the step of air-conditioning the interior of the vehicle comprises opening of sunroof by the climate modification device in such a way that fogging of the windows of the vehicle is prevented.

6. The method as claimed in claim 5, including monitoring, by said climate detection device, temperature, humidity and rain and taking into account measurement data thereof when detecting the climate in the interior of the vehicle.

7. The method as claimed in claim 5, including monitoring, by said climate detection device, temperature, humidity and rain and taking into account measurement data thereof when detecting the climate in the interior and in an area surrounding the vehicle.

8. The method as claimed in claim 1, including using a car key as a user communication unit.

9. The method as claimed in claim 1, including using a smartphone, a tablet and/or a wearable device, as a user communication unit, data from which are taken into account by the climate modification device when testing whether fogging of at least one of the windows of the vehicle is to be expected when the user enters the vehicle.

10. A computer program product for carrying out the method as claimed in claim 1.

11. A vehicle, comprising:
a user communication device carried by an identifiable user;
a vehicle communication device configured to communicate with said user communication device;
a climate detection device configured to detect climate in an interior of the vehicle; and
a climate modification device configured to modify the climate in the interior of the vehicle and prevent fogging of windows of the vehicle.

12. The vehicle of claim 11, wherein said climate detecting device is also configured to detect the climate in an area surrounding the vehicle.
